(19) United States
(12) Patent Application Publication
(10) Pub. No.: US 2023/0104284 A1
(43) Pub. Date: Apr. 6, 2023

(54) STEERING APPARATUS

(71) Applicant: KABUSHIKI KAISHA TOKAI-RIKA-DENKI-SEISAKUSHO, Niwa-gun (JP)

(72) Inventors: Takahiro FUJII, Aichi (JP); Hiroshi OHIRA, Aichi (JP); Yasumasa KONDO, Aichi (JP); Hiroshi TAKEOKA, Aichi (JP)

(21) Appl. No.: 17/952,497

(22) Filed: Sep. 26, 2022

(30) Foreign Application Priority Data
Oct. 6, 2021 (JP) 2021-164785

(51) Int. Cl. B62D 1/06; G01L 5/22

(52) U.S. Cl. CPC B62D 1/06; G01L 5/221

(57) ABSTRACT

A steering wheel in which detection is made of an electrostatic capacitance generated between a hand of an occupant and a sensor electrode of a rim section to detect contact of the occupant's hand with the rim. The sensor electrode is separated in a peripheral direction of the rim section into a first electrode and a second electrode. This enables the installation surface area of the sensor electrode to be made smaller, enabling the cost of the sensor electrode to be reduced.

### CROSS-REFERENCE TO RELATED APPLICATION

This application is based on and claims priority under 35 USC 119 from Japanese Patent Application No. 2021-164785 filed on Oct. 6, 2021, the disclosure of which is incorporated by reference herein.

### BACKGROUND

### Technical Field

The present invention relates to a steering apparatus in which a detection section detects contact of an occupant with a grip section.

### Related Art

There is an electrostatic capacitance sensor provided at a rim of a steering wheel disclosed in JP-A No. 2021-28221, and contact of an occupant with the rim section is detected by the electrostatic capacitance sensor.

In this steering wheel, the electrostatic capacitance sensor is arranged contiguously around a peripheral direction of the rim (peripheral direction of a cross-section thereof)

### SUMMARY

In consideration of the above circumstances, an object of the present invention is to obtain a steering apparatus wheel capable of reducing the cost of a detection section.

A steering apparatus of a first aspect of the present invention includes a grip section configured for an occupant to grip; and a detection section provided at the grip section, separated into a first separate portion and a second separate portion in a peripheral direction of the grip section, and configured to detect contact of the occupant with the grip section.

In the steering apparatus of the first aspect of the present invention, the occupant grips the grip section. The detection section of the grip section detects contact of the occupant with the grip section.

The detection section is separated in the grip section peripheral direction into the first separate portion and the second separate portion. This means that the detection section can be made smaller, in contrast to with a configuration in which the detection section is not separated in the grip section peripheral direction, enabling a reduction in the cost of the detection section.

A steering apparatus of a second aspect of the present invention is the steering apparatus of the first aspect of the present invention, wherein the first separate portion is disposed at an occupant side of the grip section and the second separate portion is disposed at an opposite side from the occupant side of the grip section.

In the steering apparatus of the second aspect of the present invention, the first separate portion of the detection section is disposed at the occupant side of the grip section and the second separate portion of the detection section is disposed at the opposite side from the occupant side of the grip section. This enables the detection section to detect the grip section being interposed by the occupant between the occupant side of the grip section and the opposite side from the occupant side of the grip section.

A steering apparatus of a third aspect of the present invention is the steering apparatus of the first aspect or the second aspect of the present invention, wherein the first separate portion and the second separate portion are connected together.

In the steering apparatus of the third aspect of the present invention, the first separate portion and the second separate portion of the detection section are connected together. Thus there is no need to control the first separate portion and the second separate portion separately, enabling control of the detection section to be simplified.

A steering apparatus of a fourth aspect of the present invention is the steering apparatus of any one of the first aspect to the third aspect of the present invention, wherein at least one of a range in the peripheral direction of the grip section over which the first separate portion is disposed or a range in the peripheral direction of the grip section over which the second separate portion is disposed is smaller than a. range in the peripheral direction of the grip section over which neither the first separate portion nor the second separate portion is disposed.

In the steering apparatus of the fourth aspect of the present invention, at least one of the grip section peripheral direction range over which the first separate portion is disposed or the grip section peripheral direction range over which the second separate portion is disposed is smaller than the grip section peripheral direction range over which neither the first separate portion nor the second separate portion is disposed. This enables the detection section to be made even smaller, enabling a greater reduction in cost of the detection section.

A steering apparatus of a fifth aspect of the present invention is the steering apparatus of any one of the first aspect to the fourth aspect of the present invention, wherein the detection section is disposed at an operation radial direction one side of the grip section,

In the steering apparatus of the fifth aspect of the present invention, the detection section is disposed at the operation radial direction one side of the grip section. This enables the detection section to detect contact by one hand of the occupant with the grip section.

A steering apparatus of a sixth aspect of the present invention is the steering apparatus of any one of the first aspect to the fifth aspect of the present invention further comprising a support section disposed contiguously spanning from an operation radial direction one side to an operation radial direction other side of the grip section, and configured to support the detection section disposed at the operation radial direction one side of the grip section and the detection section disposed at the operation radial direction other side of the grip section.

In the steering apparatus of the sixth aspect of the present invention, the support section supports the detection section disposed at the operation radial direction one side of the grip section and the detection section disposed at the operation radial direction other side of the grip section.

The support section is disposed contiguously spanning from the operation radial direction one side of the grip section to the operation radial direction other side of the grip section. This enables easy assembly of the detection section on the operation radial direction one side and the detection section on the operation radial direction other side to the grip section by assembling the support section to the grip section.

### BRIEF DESCRIPTION OF THE DRAWINGS

Exemplary embodiments of the present invention will be described in detail based on the following figures, wherein:

FIG. 1 is a face-on view illustrating a steering wheel according to an exemplary embodiment of the present invention viewed from a front side thereof:

FIG. 2A is a face-on view illustrating relevant portions of the steering Wheel according to the exemplary embodiment of the present invention viewed from a front side thereof;

FIG. 2B is a rear-face view illustrating relevant portions of the steering wheel according to the exemplary embodiment of the present invention viewed from a rear side thereof:

FIG. 3 is an exploded perspective view illustrating relevant portions of the steering wheel according to the exemplary embodiment of the present invention viewed from a front side thereof;

FIG. 4 is a development drawing illustrating a sensor of the steering wheel according to the exemplary embodiment of the present invention viewed from a front-face side thereof; and

FIG. 5 is a cross-section illustrating a rim section of the steering wheel according to the exemplary embodiment of the present invention (a cross-section taken along line 5-5 of FIG. 1).

### DETAILED DESCRIPTION

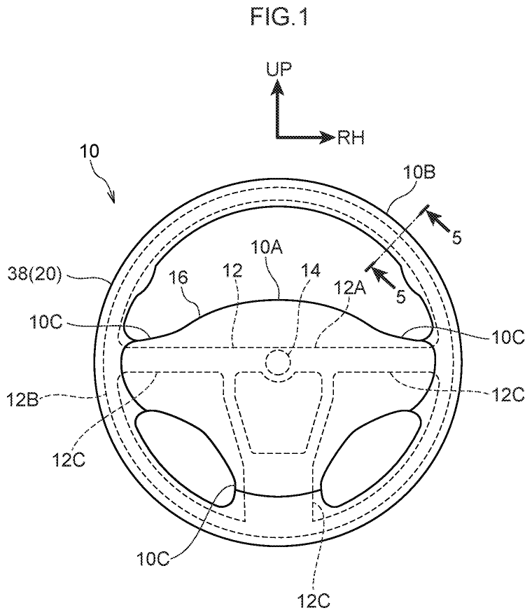

FIG. 1 is a face-on view illustrating a steering wheel 10 serving as a steering apparatus according to an exemplary embodiment of the present invention viewed from a front side thereof. Note that in the drawings an arrow FR indicates a front side of the steering wheel 10, an arrow RH indicates a right side of the steering wheel 10, and an arrow UP indicates an upper side of the steering wheel 10.

The steering wheel 10 according to the present exemplary embodiment faces toward a driver seat of a vehicle at a vehicle rear side of the steering wheel 10, with the steering wheel 10 disposed at a vehicle front side of an occupant (driver, contact person) seated in the driver seat. The front side, right side, and upper side of the steering wheel 10 face respectively toward the rear side, the right side, and the upper side of the vehicle.

As illustrated in FIG. 1, a boss section 10A is provided as a fixed section at a central portion of the steering wheel 10, and a rim section 10B having a circular ring shape in face-on view is provided as a grip section at an outer peripheral portion of the steering wheel 10. Three spokes 10C are provided as coupling sections between the boss section 10A and the rim section 10B. The spokes 10C extend from the boss section 10A toward the left side, right side, and lower side, and are coupled to the boss section 10A and to the rim section 10B,

A core 12 made from metal is provided to the steering wheel 10 as a framework member.

A plate shaped boss core 12A is provided at a central portion of the core 12, with the boss core 12A configuring the boss section 10A. The boss core 12A is fixed to a vehicle rear side end (vehicle upper side end) of a circular column shaped steering shaft 14 serving as a support shaft in the vehicle, and the steering shaft 14 is arranged so as to be coaxial to the rim section 10B. The steering wheel 10 (core 12) is supported by the steering shaft 14 so as to be able to rotate integrally therewith. The steering shaft 14 is rotated about its central axis line and the vehicle is steered by the occupant gripping the rim section 10B and performing a rotation operation on the steering wheel 10 in the circumferential direction thereof.

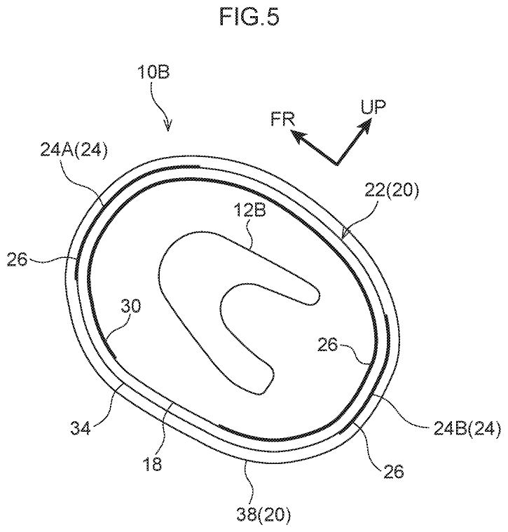

A rim core 12B (see FIG. 5) having a circular ring shape in face-on view is provided at an outer peripheral portion of the core 12, with the rim core 12B configuring the rim section 10B. Three elongated plate shaped spoke cores 12C are provided between the boss core 12A and the rim core 12B, with the spoke cores 12C extending from the boss core 12A to the left side, right side, and lower side (the radial direction outside of the steering wheel 10), and with the spoke cores 12C being integrally coupled to both the boss core 12A and the rim core 12B and configuring the spokes 10C.

A plate shaped pad 16 is provided as a covering member to the boss section 10A and the spokes 10C. The pad 16 is attached to the front side of the boss core 12A and the spoke cores 12C, with the pad 16 covering the front side of the boss core 12A and the spoke cores 12C.

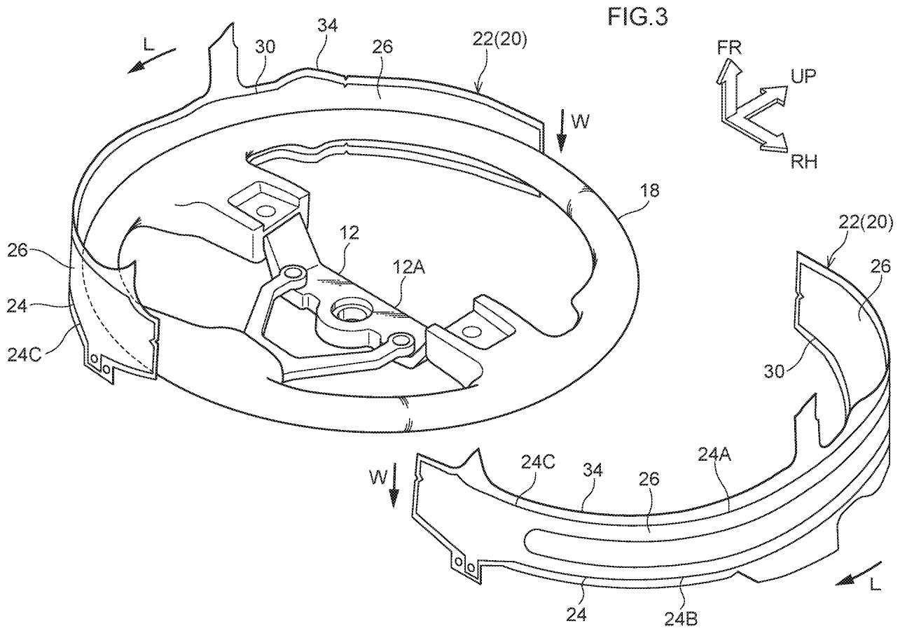

An inner member 18 (see FIG. 3 and FIG. 5) having a circular ring shape in face-on view and serving as an installation member is provided along an entire length direction of the rim section 10B (i.e. the circumferential direction of the steering wheel 10) and an entire peripheral direction (a direction of rotation about the length direction) of the rim section 10B, with the inner member 18 made from a soft resin (polyurethane, for example) and having a substantially circular shaped external profile in a cross-section perpendicular to the length direction. The rim core 12B is housed inside the inner member 18, and the inner member 18 is fixed to the rim core 12B.

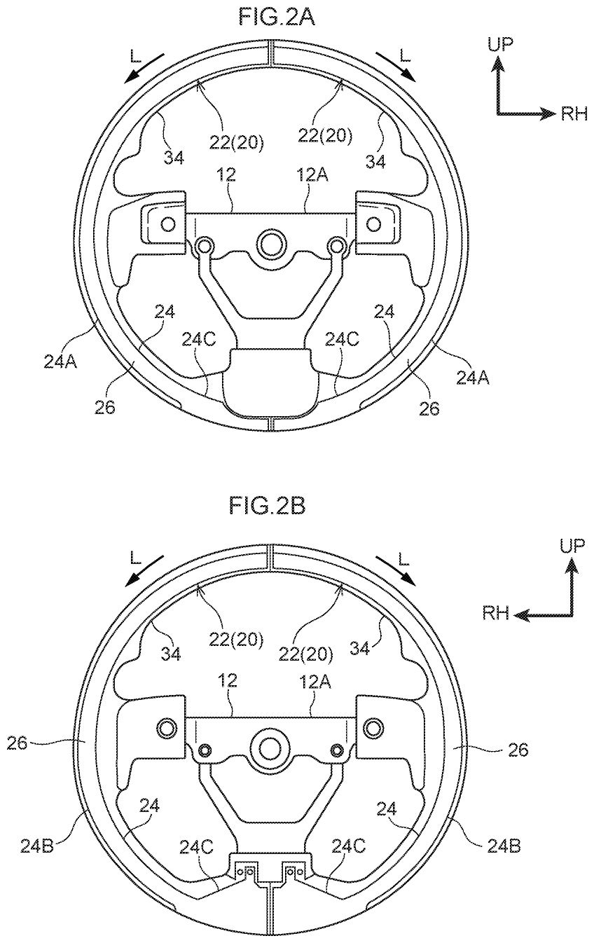

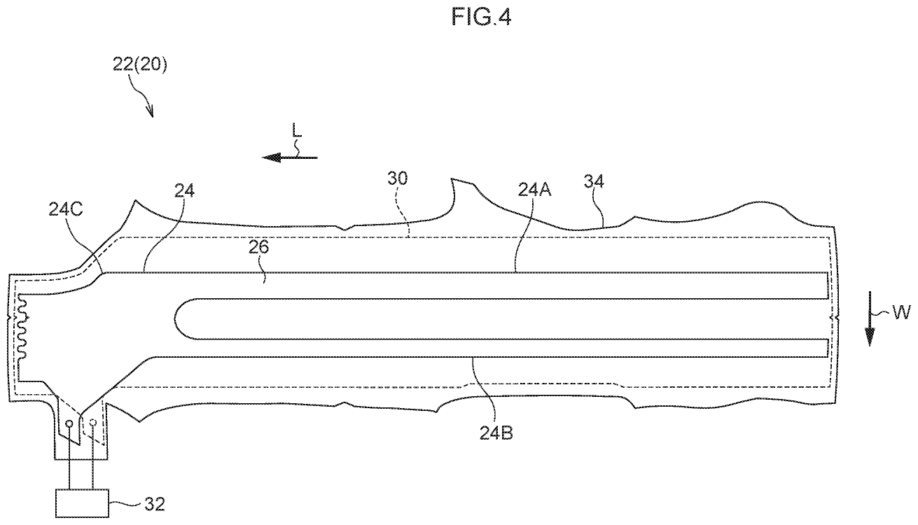

Elongated substantially rectangular sheet shaped sensors 22 (see FIG. 2A, FIG. 2B, FIG. 3, and FIG. 4) are respectively provided at a left side portion and a right side portion of the rim section 10B and serve as detection members respectively configuring a detection mechanism 20. The sensors 22 are each wrapped around and stuck to the outer periphery of the inner member 18. A length direction of the sensors 22 is disposed so as to curve along the length direction of the rim section 10B, with a length direction one side of each of the sensors 22 (a direction of arrow L of FIG. 4) facing a length direction lower side of the rim section 10B. A width direction of the sensors 22 is disposed so as to curve along the peripheral direction of the rim section 10B, with a width direction one side of the sensors 22 (a direction of arrow W of FIG. 4) facing a peripheral direction rear side of the rim section 10B. The width direction center of the sensors 22 is disposed at the steering wheel 10 radial direction outside of the rim section 10B, with the two width direction edges of the sensors 22 being disposed at the steering wheel 10 radial direction inside of the rim section 10B.

A sensor electrode 24 having an elongated substantially rectangular shape is provided as a detection section (sensor section) at a front-face side portion of each of the sensors 22 (radial direction outside portions of the rim section 10B), with the length direction one side and the width direction one side of the sensor electrodes 24 respectively facing in the same direction as the length direction one side and the width direction one side of the sensors 22. The sensor electrodes 24 are configured by metal plating 26 formed around the entire outer periphery of a cloth, with the sensor electrodes 24 exhibiting conductivity due to the metal plating 26.

Portions other than at the length direction one side end of the sensor electrodes 24 are separated in the width direction of the sensor electrodes 24 (the peripheral direction of the rim section 10B) into a first electrode 24A having an elongated substantially rectangular shape and serving as a first separate portion, and into a second electrode 24B having an elongated substantially rectangular shape and serving as a second separate portion (see FIG. 5), with the first electrode 24.A and the second electrode 2413 extending along the length direction of the sensor electrodes 24. The first electrode 24A is disposed at a width direction other side of the sensor electrode 24 and is disposed at a front side (occupant side) of the rim section 10B. The second electrode 24B is disposed at the width direction one side of the sensor electrode 24 and is disposed at a rear side of the rim section 10B (the opposite side from the occupant).

The rim section 10B peripheral direction dimension of the first electrode 24A is larger than the rim section 10B peripheral direction dimension of the second electrode 24B, with the range in the rim section 10B peripheral direction over which the first electrode 24A is disposed being larger than the range in the rim section 10B peripheral direction over which the second electrode 24B is disposed. The rim section 10B peripheral direction dimension of the first electrode 24A and the rim section 10B peripheral direction dimension of the second electrode 24B are each smaller than peripheral direction dimensions between the first electrode 24A and the second electrode 2413 at the steering wheel 10 radial direction outside and radial direction inside of the rim section 10B, and the rim section 10B peripheral direction range over which the first electrode 24A is disposed and the rim section 10B peripheral direction range over which the second electrode 24B is disposed are each smaller than each of the rim section 10B peripheral direction ranges where the first electrode 24A and the second electrode 24B are not disposed.

The length direction one side ends of the sensor electrodes 24 configure substantially rectangular shaped connection electrodes 24C serving as connection sections, with the connection electrodes 24C each connected to the first electrode 24A and the second electrode 24B and connecting (electrically connecting) the first electrode 24A and the second electrode 24B together.

A cancel electrode 30 having an elongated substantially rectangular shape and serving as a cancel section configuring the support section is provided to a back-face side portion (a rim section 10B radial direction inside portion) of each of the sensors 22, with the cancel electrodes 30 having substantially the same configuration as the sensor electrodes 24. However, portions other than the length direction one side ends portions of the cancel electrode 30 differ from the sensor electrodes 24 in that they are not separated.

A length direction one side and width direction one side end portion of each of the sensor electrodes 24 and a length direction one side and width direction one side end portion of each of the cancel electrodes 30 are each electrically connected to a control device 32 (ECU, see FIG. 4) of the vehicle.

Insulating bodies 34 having an elongated substantially rectangular sheet shape and serving as an insulation section configuring the support section are provided between the respective sensor electrodes 24 and the cancel electrodes 30, with a length direction one side and width direction one side of the insulating body 34 facing in the same direction as a length direction one side and width direction one side of each of the respective sensors 22. The insulating bodies 34 are made from resin, and the sensor electrodes 24 and the cancel electrodes 30 are fixed to the insulating bodies 34, with the insulating bodies 34 electrically insulating the sensor electrodes 24 from the cancel electrodes 30.

Leather 38 is provided over the entire outer periphery of the rim section 10B as an outer peripheral member configuring the detection mechanism 20, with the leather 38 covering the sensors 22 and configuring a front-face side (radial direction outside face) of the rim section 10B.

Next, explanation follows regarding operation of the present exemplary embodiment.

In the steering wheel 10 configured as described above, an electrostatic capacitance generated between a hand of an occupant and the sensor electrode 24 of the sensors 22 when the hand of the occupant contacts the front-face side of the leather 38 of the rim section 10B is detected by the control device 32, and this is detected as the hand of the occupant contacting the rim section 10B (the leather 38). Then when the contact surface area of the occupant's hand becomes a specific surface area or greater at the position where the sensor electrode 24 is disposed on the rim section 10B (the position where the sensor electrode 24 is disposed at the radial direction inside on the rim section 10B outer periphery), the rim section 10B is detected by the control device 32 as being gripped by the occupant when the electrostatic capacitance between the occupant's hand and the sensor electrode 24 has reached a specific electrostatic capacitance or greater. The sensor electrode 24 and the cancel electrode 30 of the sensor 22 are controlled by the control device 32 to the same electrical potential, Any parasitic capacitance generated between the sensor electrode 24 and the rim core 12B is thereby limited by the cancel electrode 30, suppressing the electrostatic capacitance generated between the hands of the occupant and the sensor electrode 24 from being changed by such parasitic capacitance, and suppressing a fall in accuracy for detection of occupant gripping of the rim section 10B.

However, the occupant needs to grip the rim section 10B appropriately in order for the occupant to perform a rotation operation on the steering wheel 10, and the rim section 10B is interposed. between the occupant's palm at the front side (occupant side) of the rim section 10B and the fingers of the occupant (for example, all the fingers except the thumb) at the rear side (opposite side from the occupant) of the rim section 10B when the occupant is gripping the rim section 10B appropriately.

The sensor electrode 24 is accordingly separated in the rim section 10B peripheral direction into the first electrode 24A and the second electrode 24B. Thus in contrast to a configuration in which a sensor electrode 24 is not separated in the rim section 10B peripheral direction, a situation can he suppressed from occurring in which the contact surface area of the occupant's hand at the position where the sensor electrode 24 is disposed on the rim section 10B gets larger, and this is detected as the occupant gripping the rim section 10B even though the occupant has not gripped the rim section 10B appropriately. Moreover, the installation surface area of the sensor electrodes 24 can be made small, enabling a reduction in the cost of the sensor electrodes 24.

Furthermore, the first electrode 24A of each of the sensor electrodes 24 is disposed at the front side of the rim section 10B, and the second electrode 2411 of the sensor electrode 24 is disposed at the rear side of the rim section 10B. Each of the sensor electrodes 24 is thereby able to detect interposing by the occupant's hand between the front side and the rear side of the rim section 10B, and an increase in the contact surface area of the occupant's hand at the position where the sensor electrode 24 is disposed on the rim section 10B is enabled in cases in which the occupant has gripped the rim section 10B appropriately, which in turn enables gripping by the occupant of the rim section 10B to be detected. Moreover, in cases in which the rim section 10B is interposed in the occupant's hand between the steering wheel 10 radial direction inside and the steering wheel 10 radial direction outside but the occupant is not gripping the rim section 10B appropriately, the contact surface area of the occupant's hand at the position where the sensor electrode 24 is disposed on the rim section 10B can be made small, enabling gripping of the rim section 10B by the occupant to he suppressed from being detected.

Moreover, the rim section 10B peripheral direction range where the first electrode 24A is disposed and the rim section 10B peripheral direction range where the second electrode 24B is disposed are each smaller than each of the rim section 10B peripheral direction ranges where neither the first electrode 24A nor the second electrode 24B is disposed in the rim section 10B peripheral direction. This enables the installation surface area of the sensor electrodes 24 to be even smaller, enabling an even greater reduction in cost of the sensor electrodes 24. Moreover, the respective rim section 10B peripheral direction ranges where neither the first electrode 24A nor the second electrode 24B is disposed are each larger than the rim section 10B peripheral direction range where the first electrode 24A is disposed or the rim section 10B peripheral direction range where the second electrode 24B is disposed. Thus in cases in which the rim section 10B is interposed by the occupant's hand between the steering wheel 10 radial direction inside and the steering wheel 10 radial direction outside but the occupant is not gripping the rim section 10B appropriately, the contact surface area of the occupant's hand at the position where the sensor electrode 24 is disposed on the rim section 10B can be made small effectively, enabling gripping of the rim section 10B by the occupant to be effectively suppressed from being detected.

Moreover, the first electrode 24A and the second electrode 24B in each of the sensor electrodes 24 are connected together by the connection electrodes 24C. This means that the control device 32 does not need to control the first electrode 24A and the second electrode 24B separately, enabling control of the sensor electrodes 24 by the control device 32 to be simplified. Moreover, the accuracy of the placement separation in the sensor electrode 24 width direction between the first electrode 24A and the second electrode 24B can be raised by the connection electrode 24C, enabling the rim section 10B peripheral direction positional accuracy to be increased for the first electrode 24A and the second electrode 24B.

Furthermore in the sensors 22, the insulating body 34 and the cancel electrode 30 are not separated in the width direction, in contrast to the sensor electrodes 24. This enables the sensors 22 to be wrapped around and stuck to the outer periphery of the inner member 18 easily, enables the sensors 22 to be assembled to the rim section 10B easily, and enables the positional accuracy for placement of the sensor electrodes 24 (including the first electrodes 24A and the second electrodes 24B) on the rim section 10B to be raised.

Moreover, as described above, in each of the sensors 22, the sensor electrode 24 is separated in the width direction into the first electrode 24A and the second electrode 24B. The sensor 22 can accordingly be curved around in the length direction and the width direction easily, enabling the sensor 22 to be wrapped around and stuck to the outer periphery of the inner member 18 easily, and enabling the sensor 22 to be assembled to the rim section 10B easily.

The sensors 22 and the sensor electrodes 24 are respectively disposed at the left side (a rotation operation radial direction one side) and disposed at the right side (a rotation operation radial direction other side) of the rim section 10B. This enables the sensor electrode 24 on the left side to detect gripping of the rim section 10B by one hand of the occupant (the left hand, for example), and enables the sensor electrode 24 on the right side to detect gripping of the rim section 10B by one hand of the occupant (the right hand, for example).

Note that in the present exemplary embodiment, the first electrode 24A and the second electrode 24B are connected together at the sensor electrode 24 length direction one side end by the connection electrode 24C. However, the first electrode 24A and the second electrode 24B may be connected together at a portion other than the length direction one side end of the sensor electrode 24 (a length direction other side end, for example) in addition thereto, or instead thereof.

Furthermore, in the present exemplary embodiment, the insulating body 34 and the cancel electrode 30 of the sensor 22 at the left side of the rim section 10B, and the insulating body 34 and the cancel electrode 30 of the sensor 22 at the right side of the rim section 10B, are formed as separate respective bodies. However, the insulating body 34 on the left side and the insulating body 34 on the right side may be integrated together, and the cancel electrode 30 on the left side and the cancel electrode 30 on the right side may be integrated together. In such cases, the left side sensor 22 and the right side sensor 22 are integrated together, and at least one of the insulating body 34 or the cancel electrode 30 are disposed contiguously spanning the left side and right side of the rim section 10B. Thus the sensor electrodes 24 at the left side and right side of the rim section 10B can be assembled easily by assembling the insulating body 34 and the cancel electrode 30 to the rim section 10B (the inner member 18 outer periphery), enabling the rim section 10B length direction positional accuracy of placement of the left side and right side sensor electrodes 24 to be raised.

What is claimed is:

1. A steering apparatus comprising:
a grip section configured for an occupant to grip; and
a detection section provided at the grip section, separated into a first separate portion and a second separate portion in a peripheral direction of the grip section, and configured to detect contact of the occupant with the grip section.

2. The steering apparatus of claim 1, wherein the first separate portion is disposed at an occupant side of the grip section and the second separate portion is disposed at an opposite side from the occupant side of the grip section.

3. The steering apparatus of claim 1, wherein the first separate portion and the second separate portion are connected together.

4. The steering apparatus of claim 1, wherein at least one of a range in the peripheral direction of the grip section over which the first separate portion is disposed or a range in the peripheral direction of the grip section over which the second separate portion is disposed is smaller than a range in the peripheral direction of the grip section over which neither the first separate portion nor the second separate portion is disposed.

5. The steering apparatus of claim 1, wherein the detection section is disposed at an operation radial direction one side of the grip section.

6. The steering apparatus of claim 1, further comprising a support section disposed contiguously spanning from an operation radial direction one side to an operation radial direction other side of the grip section, and configured to support the detection section disposed at the operation radial direction one side of the grip section and the detection section disposed at the operation radial direction other side of the grip section.

7. The steering apparatus of claim 1, wherein at least one of the first separate portion or the second separate portion extends along an operation direction of the grip section.

8. The steering apparatus of claim 1, wherein a dimension of the first separate portion in the grip section peripheral direction is larger than a dimension of the second separate portion in the grip section peripheral direction.

9. The steering apparatus of claim 1, wherein a gap dimension between the first separate portion and the second separate portion at an inner side of the grip section is larger than a gap dimension between the first separate portion and the second separate portion at an outer side of the grip section.

10. The steering apparatus of claim 1, further comprising a detection member at which the detection section is provided in a state of being separated from the first separate portion and the second separate portion.
